(19) United States
(12) Patent Application Publication
(10) Pub. No.: US 2025/0013895 A1
(43) Pub. Date: Jan. 9, 2025

(54) SYSTEM AND METHOD FOR DISTRIBUTED REASONING IN AUTONOMOUS SYSTEMS

(71) Applicant: FOUR DROBOTICS CORPORATION, Ottawa (CA)

(72) Inventors: Jeremy James, Ottawa (CA); Chidiebere Iheanyichukwu Onyedinma, Ottawa (CA)

(21) Appl. No.: 18/894,235

(22) Filed: Sep. 24, 2024

Related U.S. Application Data
(63) Continuation of application No. PCT/IB2023/053105, filed on Mar. 29, 2023.
(60) Provisional application No. 63/325,609, filed on Mar. 30, 2022.

(51) Int. Cl. G06N 5/043; G08G 1/00

(52) U.S. Cl. CPC G06N 5/043; G08G 1/22

(57) ABSTRACT

What is disclosed is a system to implement distributed reasoning for autonomous operation in a team of members, wherein the team of members comprise a first member, wherein the first member comprises a first team autonomous subsystem and first member autonomous subsystem coupled to each other, the first member executes a first hierarchical plan comprising a team plan and a first member plan, wherein the team plan is related to one or more team goals, and the first member plan is related to one or more self-goals for the first member, further wherein the execution comprises the first team autonomous system executing the team plan, and the first member autonomous system executing the first member plan.

The instant application claims priority to PCT application PCT/IB2023/053105 with an international filing date of Mar. 29, 2023, presently pending, which in turn claimed priority to U.S. provisional application 63/325,609, filed on Mar. 30, 2022, presently expired. The contents of each application are hereby incorporated by reference.

### FIELD OF THE INVENTION

The present disclosure relates to autonomous systems.

### SUMMARY

A system for autonomous operation of a device comprising: an autonomous subsystem comprising: a first autonomous reasoning engine (ARE) further comprising a plan library storing one or more plans, wherein at least some of the one or more plans are available, an event handling subsystem, a beliefs processing subsystem, an intentions processing subsystem, and a planning subsystem, wherein the plan library, the event handling subsystem, the beliefs processing subsystem, the intentions processing subsystem and the planning are coupled to each other, and a platform control system (PCS), wherein the first ARE is coupled to the PCS; the autonomous subsystem coupled to a workstation, wherein the workstation transmits a first one or more messages relating to one or more beliefs to the beliefs processing subsystem, and a second one or more messages relating to one or more events to the event handling subsystem; further wherein the PCS transmits information relating to one or more perceptions to the beliefs processing subsystem, and information relating to one or more events to the event handling subsystem, the beliefs processing subsystem determines a current belief based on the received first one or more messages and the information relating to one or more perceptions, the beliefs processing subsystem transmits the current belief to the planning subsystem and the intentions processing subsystem, the event handling subsystem determines a current event based on the received second one or more messages and the information relating to one or more events transmitted by the PCS, the event handling subsystem transmits the current event to the planning subsystem, the planning subsystem selects one of the one or more plans stored in the plan library based on the at least some of the one or more plans which are available, the current belief, and the current event, the planning subsystem transmits the selected plan to the intentions processing subsystem, the intentions processing subsystem creates a list of intentions based on the received selected plan, the intentions processing subsystem selects an intention from the created list of intentions for execution based on the created list of intentions, and the current belief, the intentions processing subsystem executes the selected intention, wherein the execution comprises the intentions processing subsystem creating one or more actions based on the selected intention, and the intentions processing subsystem transmitting the one or more actions to the PCS.

A method for autonomous operation of a device comprising storing, by the plan library, one or more plans, wherein at least some of the one or more plans are available; transmitting, by a workstation, a first one or more messages relating to one or more beliefs to a beliefs processing subsystem, and a second one or more messages relating to one or more events to an event handling subsystem; transmitting, by a platform control system (PCS), information relating to one or more perceptions to the beliefs processing subsystem, and information relating to one or more events to the event handling subsystem; determining, by the beliefs processing subsystem, a current belief based on the received first one or more messages and the information relating to one or more perceptions; transmitting, by the beliefs processing subsystem, the current belief to a planning subsystem and an intentions processing subsystem; determining, by the event handling subsystem, a current event based on the received second one or more messages and the information relating to one or more events; transmitting, by the event handling subsystem, the current event to the planning subsystem; selecting, by the planning subsystem, a plan from the one or more plans stored in the plan library based on the at least some of the one or more plans which are available, the current belief, and the current event; transmitting, by the planning subsystem, the selected plan to the intentions processing subsystem; creating, by the intentions processing subsystem, a list of intentions based on the received selected plan; selecting, by the intentions processing subsystem, an intention from the created list of intentions for execution based on the created list of intentions, and the current belief; executing, by the intentions processing subsystem, the selected intention, wherein the execution comprises creating, by the intentions processing subsystem, one or more actions based on the selected intention, and transmitting, by the intentions processing subsystem, the one or more actions to the PCS.

A system to implement distributed reasoning for autonomous operation in a team of members, wherein the team of members comprise a first member, wherein the first member comprises a first team autonomous subsystem and first member autonomous subsystem coupled to each other, the first member executes a first hierarchical plan comprising a team plan and a first member plan, wherein the team plan is related to one or more team goals, and the first member plan is related to one or more self-goals for the first member, further wherein the execution comprises the first team autonomous system executing the team plan, and the first member autonomous system executing the first member plan.

A method to implement distributed reasoning for autonomous operation in a team of members, wherein the team of members comprise a first member, wherein the first member comprises a first team autonomous subsystem and first member autonomous subsystem coupled to each other; and the method comprises: executing, by the first member, a hierarchical plan comprising a team plan and a first member plan, wherein the team plan is related to one or more team goals and the first member plan is related to one or more self-goals for the first member, the executing of the hierarchical plan comprises executing, by the first team autonomous subsystem, the team plan, and executing, by the first member autonomous system, the first member plan.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 shows an example embodiment of a system for autonomous operation.

FIG. 2 shows an example embodiment of an autonomous reasoning engine.

FIG. 3A shows an example flowchart for the operation of a system for autonomous operation.

FIG. 3B shows an example embodiment of a workstation.

FIG. 4A shows an example of the embodiment of a team with hierarchical plans for each team member.

FIG. 4B shows an example embodiment of a team autonomous subsystem and a member autonomous subsystem.

FIG. 5A shows an example embodiment of a team autonomous reasoning engine.

FIG. 5B shows an example flowchart of an operation of a team autonomous reasoning engine.

FIG. 6 shows an example embodiment of a member autonomous reasoning engine.

FIG. 7 shows an example embodiment of a flowchart of the operation of a system and method for distributed reasoning.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

An autonomous system (AS) is a system that can achieve a given set of goals in a changing environment. Autonomous systems (ASes) are able to gather information about the environment and work for extended periods of time to achieve the given set of goals without human control or intervention. Examples of such ASes are unmanned autonomous service vehicles that could be used for: perimeter security of national borders, perimeters around airports, airport runway inspection, municipal road quality surface inspection, transporting materials in a mine, agricultural cultivation, harvesting, or weed removal. In these applications, there can be one or more human supervisors monitoring via a workstation (WS) or mobile device, the progress of a team of unmanned autonomous service vehicles that can be operating in the same location or in different locations performing the same or different tasks. The human supervisor can at any time change the tasks the team or specific member of the team performs, or take direct control of an AS vehicle to perform a task that cannot be automated and the return it to the team when done.

Other examples that do not involve the use of vehicles involves the automation of process control at a refinery based upon current sensory information about the process and other parameters such as local weather and quality of raw materials used in the process, or the automation of traffic lights to reduce congestion based upon dynamic vehicle traffic information. These applications comprise human supervisors monitoring via a WS or mobile device and a distributed network of controllable intelligent input and output devices that are collecting, processing and transmitting data; and accepting control information from a distributed task planner or one or more human supervisors.

Development and testing of algorithms for an autonomous system can be difficult, as algorithms may need to be customized every time a new platform is introduced in that autonomous system. These difficulties can be reduced by using a uniform and standard model for algorithmic control and operation.

Furthermore, some applications require teams of autonomous systems to work together to achieve a given set of goals. One way to achieve this is by swarming, where each team member performs the same actions. However, swarming can result in a waste of the resources of an autonomous team.

A more resource-efficient approach is distributed reasoning. Distributed reasoning is a uniform and standard model for algorithmic control and operation of a team of autonomous team members. This approach is achieved by way of a model where each team member shares the team goals and achieves these by deriving self-goals for each team member to achieve individually. Distributed reasoning requires each team member to perform independent but collaborative actions that support the team achieving the team goals optimally, by deciding that individual team members can independently achieve sub-goals that supports the overall goal or objective of the team. Distributed reasoning is a divide and conquer approach to team work which results in a more resilient and responsive team.

Systems and methods for autonomous system operation having components to enable implementation of a uniform and standard model for algorithmic control and operation; and for implementation of distributed reasoning in a team of autonomous systems are described below.

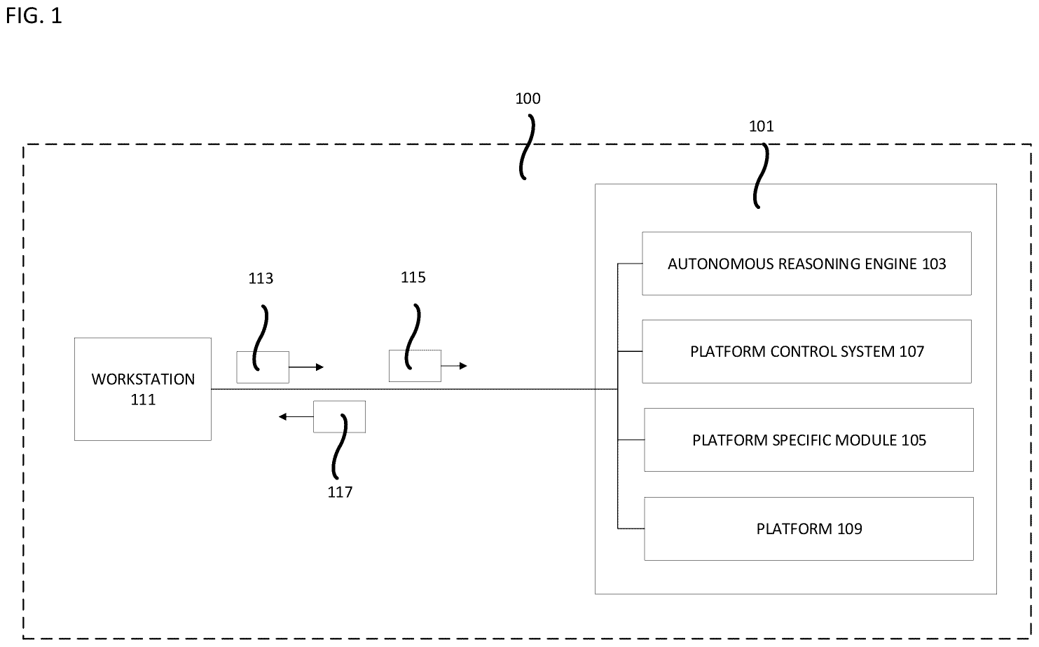

FIG. 1 shows an example embodiment of system 100. System 100 comprises an AS 101. AS 101 is installed on, for example, a device such as an unmanned vehicle. AS 101 comprises an autonomous reasoning engine (ARE) 103, a platform specific module (PSM) 105, a platform control system (PCS) 107, and a platform 109. The ARE 103, the PSM 105, the PCS 107, and the platform 109 are coupled to each other. Each of these components will be described in further detail below.

AS 101 is coupled to workstation (WS) 111. WS 111 transmits one or more plans 113 and one or more messages 115 to AS 101. AS 101 transmits telemetry 117 to WS 111. Each plan within one or more plans 113 comprises a definition of goals or objectives for AS 101 to achieve. In some embodiments, WS 111 may perform one or more processing tasks which AS 101 cannot perform, for example, image recognition or image classification.

Each of the one or more messages 115 either control or provide new data to the AS 101 to affect which plan is executed or how the plan is executed. In some embodiments, at least one of the one or more messages relate to beliefs. In some embodiments, at least one of the one or more messages relate to events. Events comprise information related to unexpected occurrences such as:
Failures, for example, mechanical or electrical failure, and
Temperature or other environmental warnings.

Telemetry 117 comprises information reported by AS 101 to WS 111 so that an operator can monitor the progress of AS 101 as it executes plans.

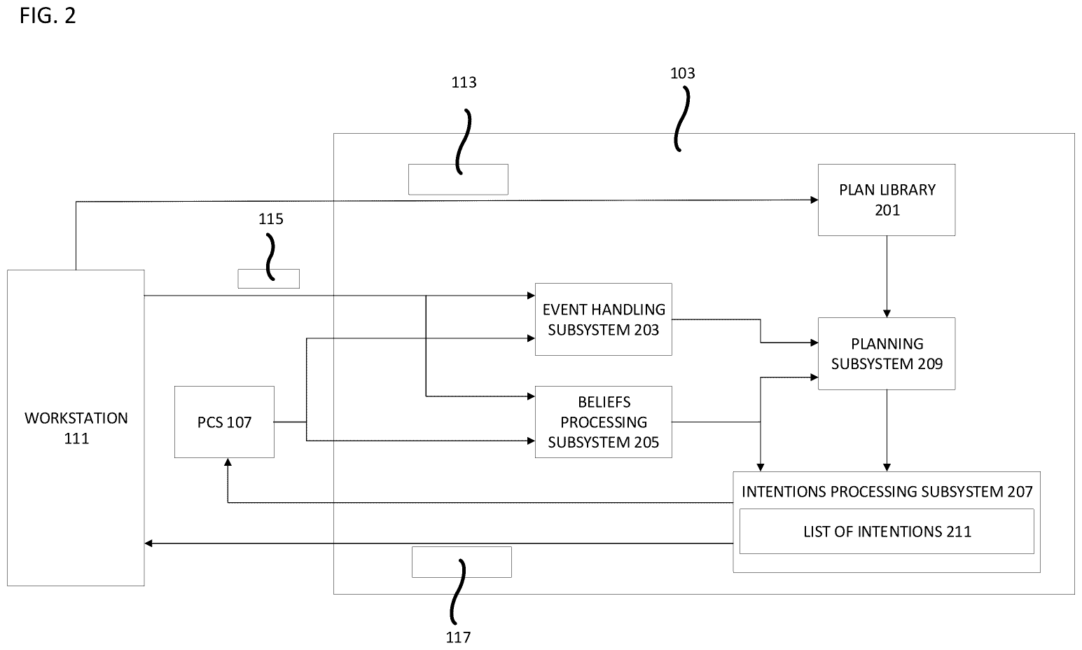

FIG. 2 shows an example embodiment of ARE 103. ARE 103 comprises a plan library 201, an event handling subsystem 203, a beliefs processing subsystem 205, an intentions processing subsystem 207, and a planning subsystem 209. The plan library 201, the event handling subsystem 203, the beliefs processing subsystem 205, the intentions processing subsystem 207 and the planning subsystem 209 are communicatively coupled to each other.

As explained above and shown in FIG. 2, WS 111 transmits one or more plans 113 to AS 101. The one or more plans 113 are received by plan library 201 for storage by the plan library 201. In some embodiments, the plan library 201 comprises a database to store the plans transmitted by WS 111. In some embodiments, plan library 201 is implemented in software. In other embodiments, plan library 201 is implemented in hardware. In yet other embodiments, plan library 201 is implemented using a combination of hardware and software.

Event handling subsystem 203 determines a current event. It performs this determination based on, for example, the at least one of the one or more of the messages 115 received from the WS 111 relating to one or more events, and information relating to one or more events transmitted by the PCS 107, as will be explained in further detail below.

Event handling subsystem 203 then transmits the current event to planning subsystem 209. In some embodiments, event handling subsystem 203 is implemented in software. In other embodiments, event handling subsystem 203 is implemented in hardware. In yet other embodiments, event handling subsystem 203 is implemented using a combination of hardware and software.

Beliefs processing subsystem 205 determines a current belief. It performs this determination based on, for example:
the at least one of the one or more of the messages 115 received from the WS 111 relating to one or more beliefs, and
information relating to one or more perceptions transmitted by the PCS 107, as will be explained in further detail below.

Beliefs processing subsystem 205 then transmits the current event to planning subsystem 209, and intentions processing subsystem 207. In some embodiments, beliefs processing subsystem 205 is implemented in software. In other embodiments, beliefs processing subsystem 205 is implemented in hardware. In yet other embodiments, beliefs processing subsystem 205 is implemented using a combination of hardware and software.

Planning subsystem 209 selects a plan from plan library 201 for execution by the intentions processing subsystem 207. In some embodiments, it performs this selection based on
the plans available in plan library 201,
the current belief as determined by beliefs processing subsystem 205, and
the current event as determined by event handling subsystem 203.
   The planning subsystem 209 transmits the selected plan to intentions processing subsystem 207. In some embodiments, planning subsystem 209 is implemented in software. In other embodiments, planning subsystem 209 is implemented in hardware. In yet other embodiments, planning subsystem 209 is implemented using a combination of hardware and software.

Intentions processing subsystem 207 performs several different functions related to the processing and executing of intentions, comprising:
Developing intentions based upon the beliefs and list of plans applicable to the current beliefs,
Selecting an optimal intention to execute,
Sending actions appropriate to the selected intention to PCS 107 for execution, and
Sending progress updates to WS 111 via telemetry.

Returning to FIG. 1, PSM 105 generalizes platform 109. The PSM 105 is an abstraction of hardware and software that interfaces directly with one or more processing elements, actuators, emitters, or sensors on the platform 109, and it also interfaces with PCS 107. The abstraction provided by the PSM separates the platform 109 specific items such as processing elements, actuators, emitters, or sensors from the implementation of one or more algorithms running on the PCS 107. Therefore PSM 105 converts the control and operation of specific hardware on a platform to a uniform standard model for algorithmic control and operation by the PCS 107. The benefit of the PSM is that PCS algorithms are independent of platform-specific items, and, therefore can be tested on any type of platform without change. This reduces the previously mentioned difficulties due to development and testing. Examples of platforms are different types of ground robots or a software simulation of a ground robot. In some embodiments, PSM 105 is implemented in software. In other embodiments, PSM 105 is implemented using a combination of hardware and software.

As explained previously, intentions processing subsystem 207 transmits one or more actions to the PCS 107 for execution. The PCS 107 receives these one or more actions, and converts these one or more actions into commands for control of platform 109. Other functions performed by the PCS 107 include:
Retrieving information from platform 109, for example, from sensors in platform 109;
Transmitting information to ARE 103. This includes:
   Transmitting one or more perceptions to beliefs processing subsystem 205. The one or more perceptions comprise an interpretation of the environment where the AS 101 is operating. Examples of interpretations comprise:
      Location of known objects,
      Detected new objects,
      Geo-location information, and
      Positional and motion information, for example:
         acceleration,
         speed, and
         the direction of travel;
   Transmitting information relating to one or more events to event handling subsystem 203.
      In some embodiments, PCS 107 is implemented in software. In other embodiments, PCS 107 is implemented using a combination of hardware and software.

Platform 109 comprises hardware necessary for the operation of the device that AS 101 is installed on. Platform 109 comprises, for example, sensors, actuators, emitters, computing elements and communications subsystems such as radios.

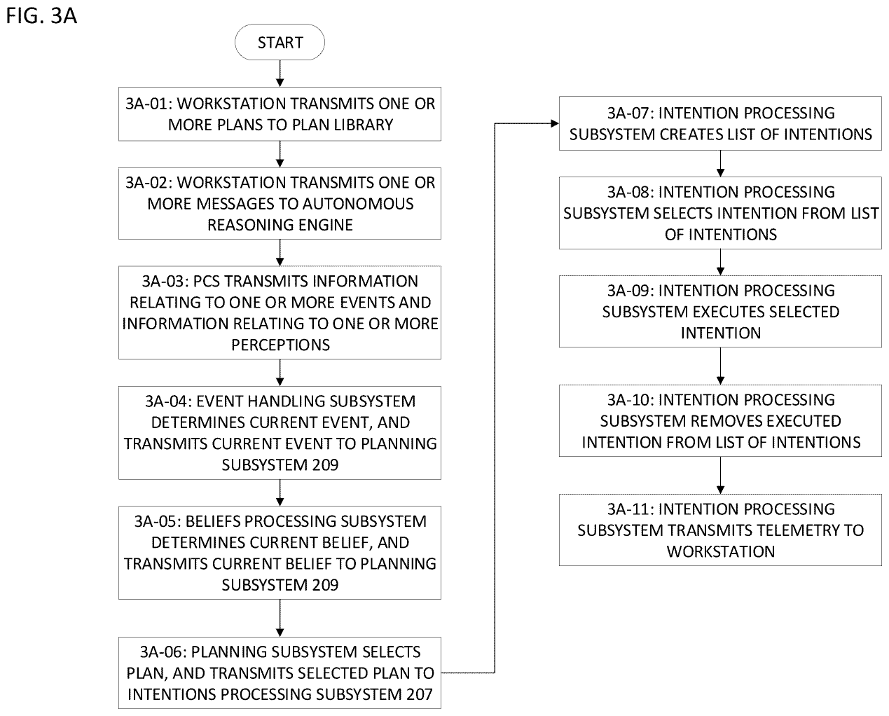

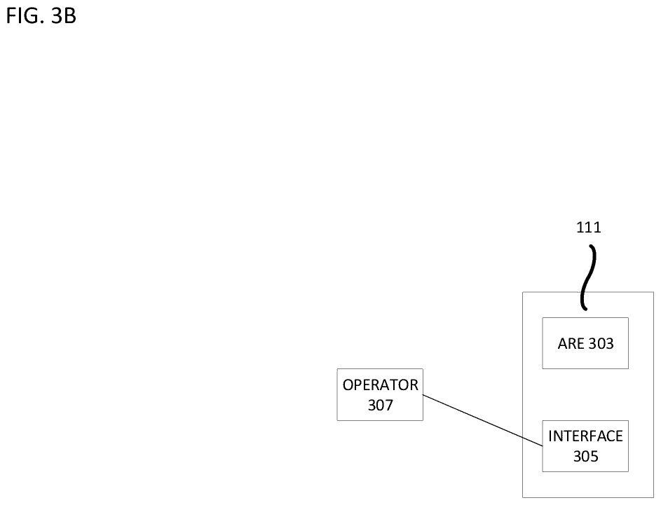

FIG. 3A shows an example flowchart for the operation of system 100. This flowchart is described below with reference to FIGS. 1 and 2.

In step 3A-01, WS 111 transmits one or more plans 113 to plan library 201.

In step 3A-02, WS 111 transmits one or more of the messages 115 to ARE 103. As explained previously, in some embodiments at least one of the one or more messages 115 are related to one or more events. In other embodiments, at least one of the one or more messages 115 are related to one or more beliefs. The at least one message related to events is transmitted to the event handling subsystem 203. The at least one message related to beliefs is transmitted to the beliefs processing subsystem 205.

In step 3A-03, the PCS 107 transmits information relating to one or more events and information relating to one or more perceptions. The information relating to one or more events is transmitted to the event handling subsystem 203. The information relating to one or more perceptions is transmitted to the beliefs processing subsystem 205.

In step 3A-04, the event handling subsystem 203 determines the current event based on:
The information relating to one or more events transmitted by PCS 107; and
The at least one message related to events transmitted by the WS 111.
   The event handling subsystem 203 transmits the current event to planning subsystem 209.

In step 3A-05, the beliefs processing subsystem 205 determines the current belief based on:
The information relating to one or more perceptions transmitted by PCS 107; and
The at least one message related to beliefs transmitted by the WS 111.
   The beliefs processing subsystem 205 transmits the current belief to planning subsystem 209, and intentions processing subsystem 207.

In step 3A-06, the planning subsystem 209 selects a plan from the plan library 201 based on:
The available plans in plan library 201,
The current belief; and
The current event.
   The planning subsystem 209 transmits the selected plan to the intentions processing subsystem 207.

In step 3A-07, the intention processing subsystem 207 creates the list of intentions 211 for execution one at a time. The list of intentions 211 is created based on the transmitted selected plan.

In step 3A-08, the intention processing subsystem 207 selects an intention from the list of intentions 211 for execution based on:
The intentions within the created list of intentions, and
The current belief received from beliefs processing subsystem 205.

In step 3A-09, the intentions processing subsystem 207 executes the selected intention. In some embodiments, this comprises:
converting the selected intention into one or more actions; and
transmitting the one or more actions to the PCS 107, which the PCS 107 converts into commands for control of platform 109.

In step 3A-10, the intentions processing subsystem 207 removes the executed intention from the list of intentions 211.

In step 3A-11, the intentions processing subsystem 207 sends progress updates to WS 111 via transmitting telemetry 117 to WS 111. This enables WS 111 to monitor the progress of AS 101 as it executes plans.

In some embodiments, WS 111 is also an autonomous subsystem. An example embodiment is shown in FIG. 3B. In FIG. 3B, WS 111 comprises ARE 303. WS 111 provides an interface 305 for an operator 307 to monitor the execution of AS 101.

In the embodiments where the WS and AS are autonomous subsystems, the WS and AS need to coordinate with each other. It is cognitively difficult for an operator such as operator 307 in FIG. 3B to monitor the execution of two or more autonomous subsystems in, for example, a combined team of autonomous subsystems. Distributed reasoning can help reduce this difficulty. Distributed reasoning enables the operator to make plans for the combined team of autonomous subsystems and monitor the execution of team plans. As explained previously, distributed reasoning is an approach whereby each team member shares the team goals and achieves these by deriving self-goals for each team member to achieve individually.

The members of the combined team comprise WS and non-WS autonomous subsystems. The WS members are not necessarily limited to one WS. Therefore, the combined team may comprise one or more WS autonomous subsystems and one or more non-WS autonomous subsystems.

Implementation of distributed reasoning requires collaboration between all of the members of the combined team. Collaboration is achieved by sharing beliefs and hierarchical plans. This is explained below.

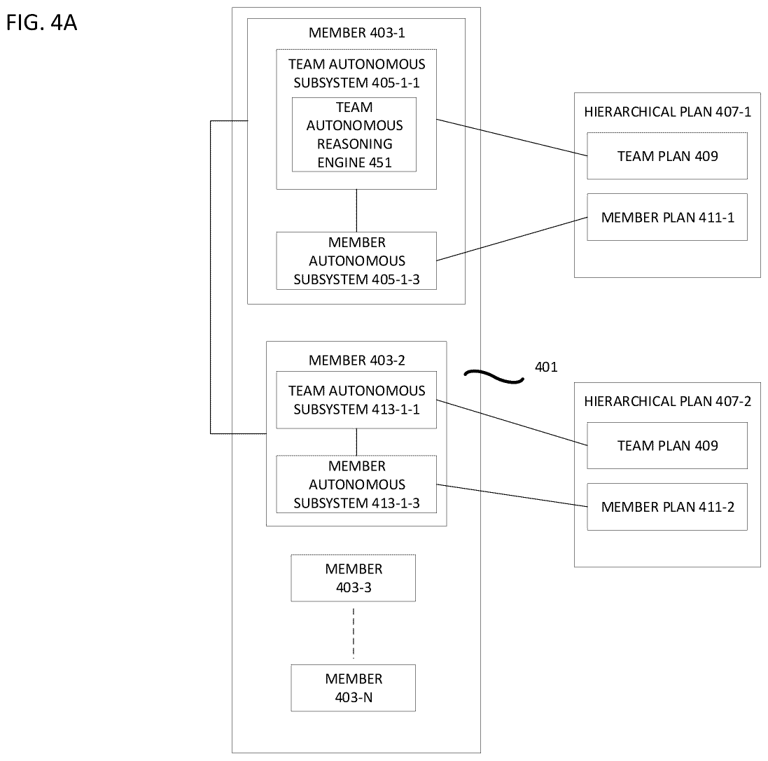

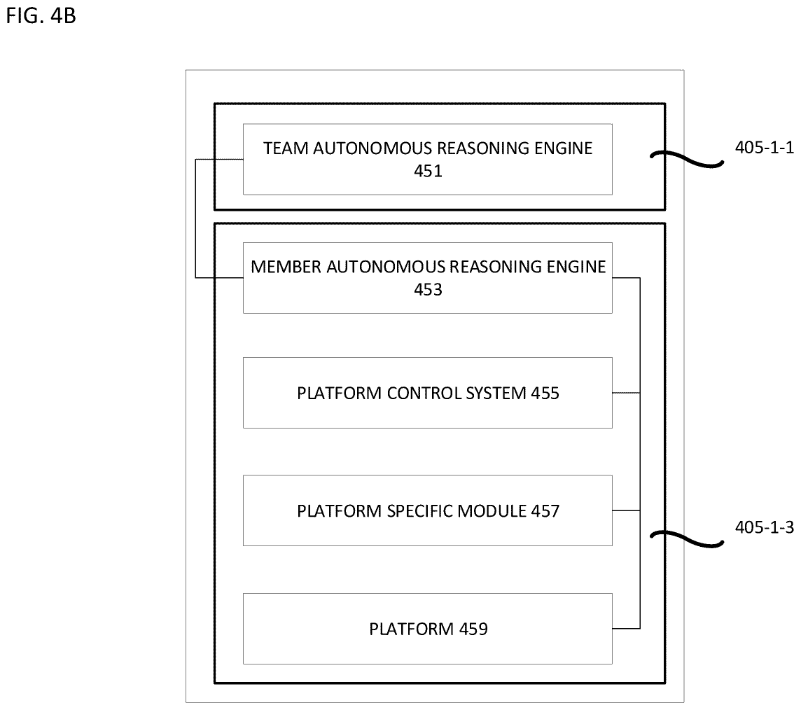

A system and method for implementation of distributed reasoning in a team comprising a plurality of members is shown below. In FIG. 4A, team 401 comprises members 403-1 to 403-N. Each member executes a hierarchical plan. For example, member 403-1 executes a hierarchical plan 407-1; and member 403-2 executes a hierarchical plan 407-2. In some embodiments, member 403-1 is coupled to at least one of members 403-2 to 403-N. For example, as shown in FIG. 4A, member 403-1 is coupled to member 403-2.

Hierarchical plan 407-1 comprises team plan 409 and member plan 411-1. Hierarchical plan 407-2 comprises team plan 409 and member plan 411-2. Team plan 409 is the same on each member 403-1 to 403-N and relates to the team goals. Member plans relate to the self-goals for each member. Member plans may be similar to each other, or differ from each other, as the self-goals for each member may be similar to, or differ from each other. For example, in some embodiments, member plan 411-1 is identical to member plan 411-2. In other embodiments, member plan 411-1 is different to member plan 411-2. The derivation of member plans will be explained below.

Member 403-1 comprises team autonomous subsystem 405-1-1 and member autonomous subsystem 405-1-3 coupled to each other. Team plan 409 is executed by team autonomous subsystem 405-1-1. Member plan 411-1 is executed by member autonomous subsystem 405-1-3. Team autonomous subsystem 405-1-1 is also coupled to the other team autonomous subsystems on the other members of the team. For example, member 403-2 comprises team autonomous subsystem 413-1-1 and member autonomous subsystem 413-3. Then, team autonomous subsystem 405-1-1 is coupled to team autonomous subsystem 413-1-1. Additionally, member autonomous subsystem 405-1-3 is coupled to team autonomous subsystems on the other members of the team.

Team autonomous subsystem 405-1-1 comprises a team autonomous reasoning engine (ARE) 451.

FIG. 4B shows an example embodiment of team autonomous subsystem 405-1-1 and member autonomous subsystem 405-1-3. Team autonomous subsystem 405-1-1 comprises team ARE 451, while member autonomous subsystem 405-1-3 comprises member ARE 453, PCS 455, PSM 457 and platform 459. PCS 455, PSM 457 and platform 459 are similar to PCS 107, PSM 105 and platform 109 respectively.

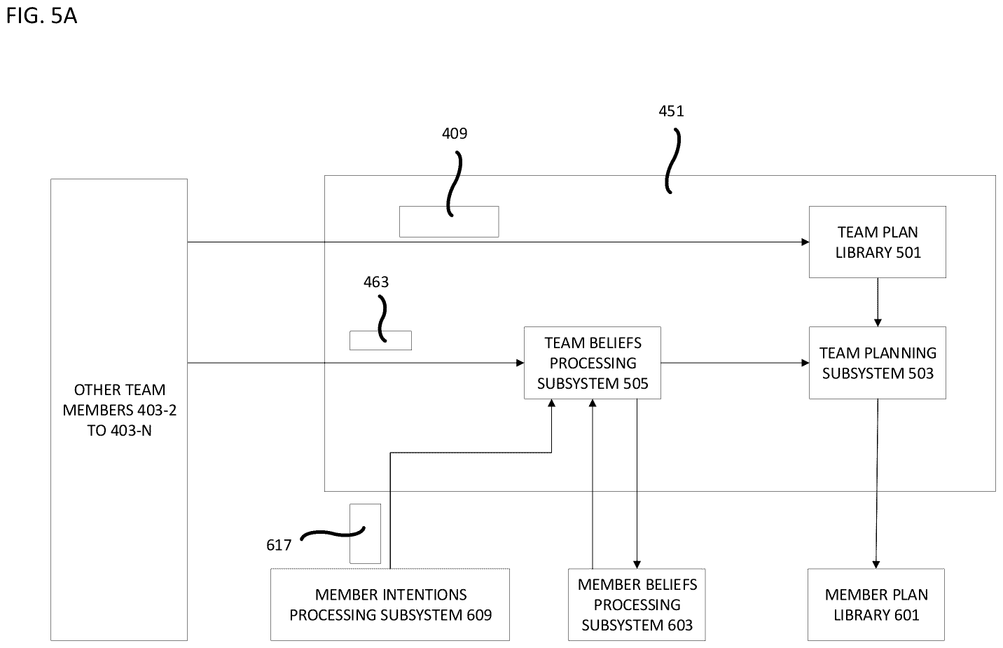

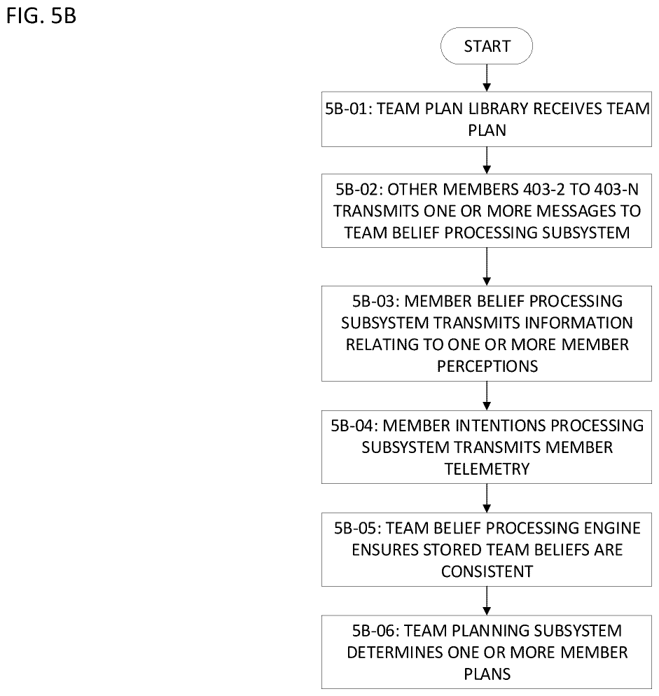

FIG. 5A shows an example embodiment of team ARE 451. Team ARE 451 comprises team plan library 501, team beliefs processing subsystem 505, and team planning subsystem 503. These components play similar roles as plan library 201, beliefs processing subsystem 205 and planning subsystem 209. Team plan library 501, team beliefs processing subsystem 505 and team planning subsystem 503 are communicatively coupled to each other.

Team plan library 501 stores the hierarchical plans for the team member, which includes team plans received from other team members. As mentioned previously, the team plans 409 are the same for each team member. In some embodiments, the team plan library 501 comprises a database to store the hierarchical plans. In some embodiments, team plan library 501 is implemented in software. In other embodiments, team plan library 501 is implemented in hardware. In yet other embodiments, team plan library 501 is implemented using a combination of hardware and software.

Team beliefs processing subsystem 505 receives the one or more messages related to one or more team beliefs received from the other team members, and the member beliefs from member beliefs processing subsystem 603. Based on the received one or more messages and the received member beliefs, team beliefs processing subsystem 505 keeps the team beliefs stored in the team beliefs processing subsystem 505 current, that is, consistent with the team beliefs on all team members. As will be explained below, the team belief processing subsystem 505 sends a member specific belief update to member beliefs processing subsystem 603, and transmits current team beliefs to team planning subsystem 503.

Team planning subsystem 503 determines one or more member plans based on the team plan and the current team belief. As will be shown below, the derived one or more member plans are stored in member plan library 601.

FIG. 5B shows an example flowchart of operation of team ARE 451. The operation of team ARE 451 is explained with reference to FIGS. 5A and 5B.

In step 5B-01, team plan library 451 receives and stores team plan 409 from the other team members 403-2 to 403-N.

In step 5B-02, similar to as explained before, team beliefs processing subsystem 505 receives one or more messages 463 from other team members 403-2 to 403-N. At least one of the one or more messages 463 relates to one or more team beliefs.

In step 5B-03, a member belief processing subsystem 603 residing within the member autonomous reasoning engine 453 transmits information relating to one or more member beliefs to team beliefs processing subsystem 505.

In step 5B-04, member intentions processing subsystem 609 residing within member ARE 453 transmits member telemetry 617 to team beliefs processing subsystem 505. In some embodiments, member telemetry 617 is used to derive or update one or more team beliefs.

In step 5B-05, team beliefs processing subsystem 505 ensures that the team beliefs stored in the team beliefs processing subsystem 505 are current, that is, as explained previously, consistent with team beliefs on all team members. The team belief processing subsystem 505 then sends a member belief update to member beliefs processing subsystem 603, wherein the member belief update is based on
the at least one message related to one or more team beliefs received from the other team members 403-2 to 403-N, and
the information relating to one or more member beliefs transmitted by member beliefs processing subsystem 603.
   Team beliefs processing subsystem 505 then stores the current team beliefs, as well as transmitting these team beliefs to team planning subsystem 503.

In step 5B-06, team planning subsystem 503 determines one or more member plans based on:
team plan 409 stored in team plan library 501; and
the current team beliefs received from team beliefs processing subsystem 505.
   Team planning subsystem 503 then transmits the one or more member plans to the member ARE 453 residing within the member autonomous subsystem 405-1-3.

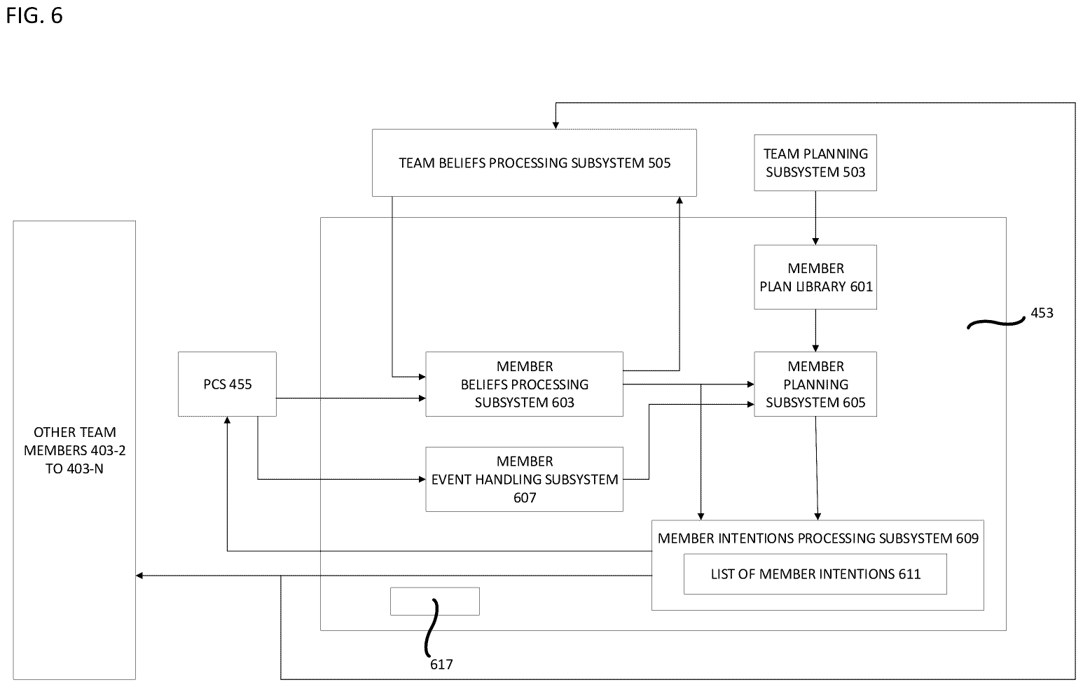

FIG. 6 shows an example embodiment of member ARE 453. Member ARE 453 comprises a member plan library 601, member beliefs processing subsystem 603, member planning subsystem 605, member event handling subsystem 607 and member intentions processing subsystem 609. Member plan library 601, member beliefs processing subsystem 603, member planning subsystem 605, member event handling subsystem 607 and member intentions processing subsystem 609 are coupled to each other. As explained above, member autonomous subsystem 405-1-3 is coupled to team autonomous subsystem 405-1-1.

Member plan library 601 stores the one or more member plans transmitted by team planning subsystem 503 to member ARE 453 as described previously. In some embodiments, the member plan library 601 comprises a database to store the received member plans. In some embodiments, member plan library 601 is implemented in software. In other embodiments, member plan library 601 is implemented in hardware. In yet other embodiments, member plan library 501 is implemented using a combination of hardware and software.

Member beliefs processing subsystem 603 determines the current member belief based on, for example:
information relating to one or more perceptions transmitted by the PCS 455; and
the current team belief transmitted by team beliefs processing subsystem 505.

Member event handling subsystem 607 determines the current member event based on the information relating to one or more events transmitted by PCS 455.

Member intentions processing subsystem 609 performs several different functions related to the processing and executing of member intentions, comprising:
Developing member intentions based upon the member beliefs and list of plans applicable to the current beliefs,
Selecting an optimal member intention to execute,
Sending actions appropriate to the selected member intention to PCS 455 for execution, and
Sending progress updates to the other team members 403-2 to 403-N and team beliefs processing subsystem 503.

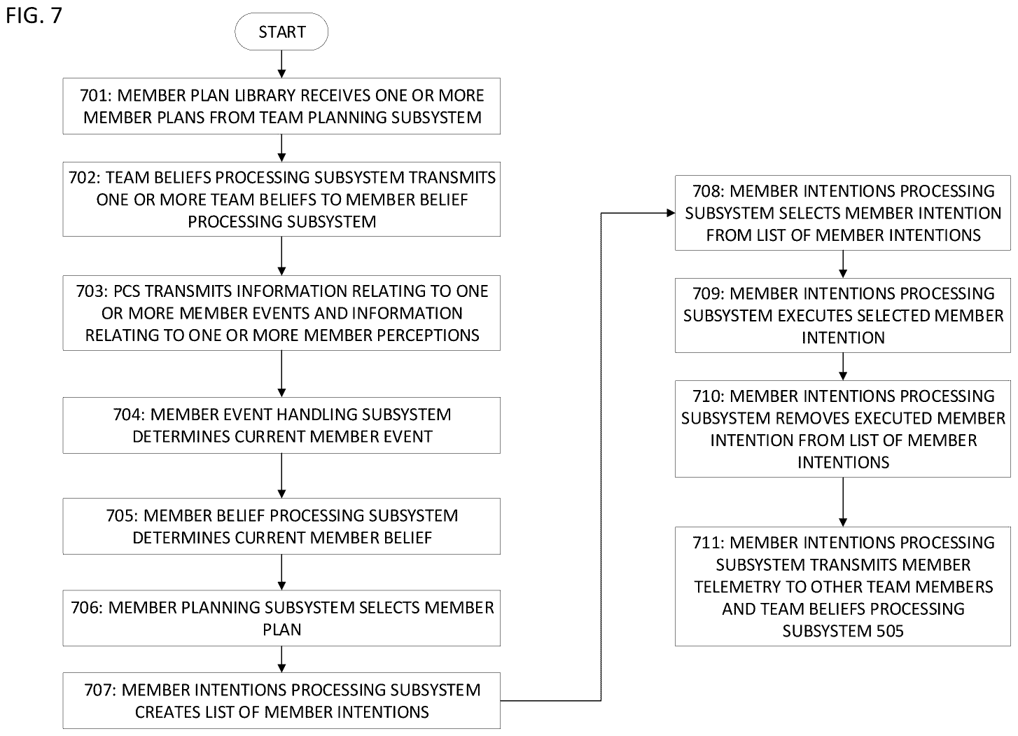

FIG. 7 shows an example embodiment of a flowchart of the operation of the system and method for distributed reasoning. The description below is made with reference to FIGS. 6-7.

In step 701, member plan library 601 receives the one or more member plans from team planning subsystem 503.

In step 702, team beliefs processing subsystem 505 transmits one or more member belief updates to member beliefs processing subsystem 603.

In step 703, PCS 455 transmits information relating to one or more member perceptions to member beliefs processing subsystem 603, and information relating to one or more member events to member event handling subsystem 607.

In step 704, member event handling subsystem 607 determines a current member event based on the information relating to one or more member events transmitted by the member PCS 455. Member event handling subsystem 607 transmits the current member event to member planning subsystem 605.

In step 705, member beliefs processing subsystem 603 determines a current member belief based on:
the one or more member belief updates transmitted by team beliefs processing subsystem 505, and
the information relating to one or more member perceptions transmitted by PCS 455.
   Member beliefs processing subsystem 603 transmits the current member belief to member planning subsystem 605, and member intentions processing subsystem 609.

In step 706, member planning subsystem 605 selects a member plan based on
The member plans are available in member plan library 601,
The received current member belief, and
The received current member event.

Member planning subsystem 605 transmits the selected member plan to member intentions processing subsystem 609.

In step 707, member intentions processing subsystem 609 creates a list of member intentions for execution 611 based on the received selected member plan.

In step 708, member intentions processing subsystem 609 selects one of the member intentions from the list of member intentions 611 for execution, based on:
The list of member intentions 611, and
The received current member belief.

In step 709, member intentions processing subsystem 609 executes the selected intention by:
Converting the selected member intention into one or more member actions; and
Transmitting the one or more member actions to the member PCS 455 for transmission to PSM 457 and execution by platform 459.

In step 710, member intentions processing subsystem 609 removes the executed intention from the list of member intentions.

In step 711, member intentions processing subsystem 609 performs a progress update by transmitting member telemetry 617 to other team members 403-2 to 403-N and team beliefs processing subsystem 505.

In some embodiments, each of the members 403-1 to 403-N of team 401 broadcasts team communications to all the other team members. This removes the need for full meshed connections between team members.

In other embodiments, the team members 403-1 to 403-N determine a leader for team 401 dynamically, based on continuous communications between the team members.

In some embodiments, when there is a break in continuous communications between team members, then one or more fragments of the team form. This is communicated as a team event, and one or more team leaders corresponding to the one or more fragments are determined.

If a first fragment and a second fragment re-join to create a re-formed fragment, a team event is communicated and a new team leader for the re-formed fragment is determined.

In yet other embodiments, a fragment that does not comprise a WS will run out of team plans to execute, or reach a state where it needs communications with the WS to proceed. In some of these embodiments, this prompts the fragment to try and re-join another fragment to create a re-formed fragment.

The systems and methods described above, can be applied in a variety of fields. For example, the systems and methods described above can be used in unmanned autonomous service vehicles for border control, perimeter security, several forms of infrastructure monitoring, forest fire prevention and detection, mining, construction, transportation, agriculture, and landscaping. The systems and methods described above can also be used in fields such as industrial control and traffic management. The systems and methods described above to implement distributed reasoning result in more efficient usage of the resources of an autonomous team, thereby leading to improved efficiency in achieving goals and other potential advantages, such as reduced power consumption and faster execution times for a given set of goals. As explained before, distributed reasoning is a divide and conquer approach to team work which results in a more resilient and responsive team.

In one example embodiment, a system for autonomous operation of a device comprising: an autonomous subsystem comprising: a first autonomous reasoning engine (ARE) further comprising a plan library storing one or more plans, wherein at least some of the one or more plans are available, an event handling subsystem, a beliefs processing subsystem, an intentions processing subsystem, and a planning subsystem, wherein the plan library, the event handling subsystem, the beliefs processing subsystem, the intentions processing subsystem and the planning subsystem are coupled to each other, and a platform control system (PCS). The first ARE is coupled to the PCS. The autonomous subsystem is coupled to a workstation, wherein the workstation transmits a first one or more messages relating to one or more beliefs to the beliefs processing subsystem, and a second one or more messages relating to one or more events to the event handling subsystem. The PCS transmits information relating to one or more perceptions to the beliefs processing subsystem, and information relating to one or more events to the event handling subsystem. The beliefs processing subsystem determines a current belief based on the received first one or more messages and the information relating to one or more perceptions. The beliefs processing subsystem transmits the current belief to the planning subsystem and the intentions processing subsystem. The event handling subsystem determines a current event based on the received second one or more messages and the information relating to one or more events transmitted by the PCS. The event handling subsystem transmits the current event to the planning subsystem. The planning subsystem selects one of the one or more plans stored in the plan library based on the at least some of the one or more plans which are available, the current belief, and the current event. The planning subsystem transmits the selected plan to the intentions processing subsystem. The intentions processing subsystem creates a list of intentions based on the received selected plan. The intentions processing subsystem selects an intention from the created list of intentions for execution based on the created list of intentions, and the current belief. The intentions processing subsystem executes the selected intention, wherein the execution comprises the intentions processing subsystem creating one or more actions based on the selected intention, and the intentions processing subsystem transmitting the one or more actions to the PCS.

In one or more of the above examples, the workstation transmits at least one plan to the plan library for storage. The workstation comprises a second ARE, and the workstation comprises an interface to enable an operator to interact with the workstation.

In one or more of the above examples, the autonomous subsystem comprises a platform specific module (PSM) and a platform; and the first ARE, the PCS, the PSM, and the platform are coupled to each other. The platform comprises platform hardware for operation of the device, and the PSM converts control and operation of the platform hardware to a uniform standard model.

In one or more of the above examples, the PSM separates the platform hardware from implementation of one or more algorithms running on the PCS.

In one or more of the above examples, the intentions processing subsystem removes the executed intention from the list of intentions.

In one or more of the above examples, the intentions processing subsystem transmits telemetry to the workstation to enable the workstation to monitor the autonomous subsystem.

In one or more of the above examples, the PCS receives the one or more actions, and the PCS converts the one or more actions into commands for control of the platform.

In one example embodiment, a method for autonomous operation of a device comprising storing, by a plan library, one or more plans, wherein at least some of the one or more plans are available; transmitting, by a workstation, a first one or more messages relating to one or more beliefs to a beliefs processing subsystem, and a second one or more messages relating to one or more events to an event handling subsystem; transmitting, by a platform control system (PCS), information relating to one or more perceptions to the beliefs processing subsystem, and information relating to one or more events to the event handling subsystem; determining, by the beliefs processing subsystem, a current belief based on the received first one or more messages and the information relating to one or more perceptions; transmitting, by the beliefs processing subsystem, the current belief to a planning subsystem and an intentions processing subsystem; determining, by the event handling subsystem, a current event based on the received second one or more messages and the information relating to one or more events; transmitting, by the event handling subsystem, the current event to the planning subsystem; selecting, by the planning subsystem, a plan from the one or more plans stored in the plan library based on the at least some of the one or more plans which are available, the current belief, and the current event; transmitting, by the planning subsystem, the selected plan to the intentions processing subsystem; creating, by the intentions processing subsystem, a list of intentions based on the received selected plan; selecting, by the intentions processing subsystem, an intention from the created list of intentions for execution based on the created list of intentions, and the current belief; executing, by the intentions processing subsystem, the selected intention, wherein the execution comprises creating, by the intentions processing subsystem, one or more actions based on the selected intention, and transmitting, by the intentions processing subsystem, the one or more actions to the PCS.

In one or more of the above examples, the workstation comprises a second ARE, and the workstation comprises an interface to enable an operator to interact with the workstation. The method further comprises transmitting, by the workstation, at least one plan to the plan library for storage.

In one or more of the above examples, the method further comprises converting, by a platform-specific module (PSM), control and operation of platform hardware within a platform to a uniform standard model.

In one or more of the above examples, the PSM separates the platform hardware from the implementation of one or more algorithms running on the PCS.

In one or more of the above examples, the method further comprises removing, by the intentions processing subsystem, the executed intention from the list of intentions.

In one or more of the above examples, the plan library, the event handling subsystem, the beliefs processing subsystem, the intentions processing subsystem, the planning subsystem, the PSM, the PCS, and the platform, reside on an autonomous subsystem. The method further comprises transmitting, by the intentions processing subsystem, telemetry to the workstation to enable the workstation to monitor the autonomous subsystem.

In one or more of the above examples, the method further comprises: receiving, by the PCS, the one or more actions; and converting, by the PCS, the one or more actions into commands for control of the platform.

In one example embodiment, a system to implement distributed reasoning for autonomous operation in a team of members. The team of members comprises a first member, wherein the first member comprises a first team autonomous subsystem and first member autonomous subsystem coupled to each other. The first member executes a first hierarchical plan comprising a team plan and a first member plan, wherein the team plan is related to one or more team goals, and the first member plan is related to one or more self-goals for the first member. The execution comprises the first team autonomous system executing the team plan, and the first member autonomous system executing the first member plan.

In one or more of the above examples, the team of members comprises a second member coupled to the first member. The second member comprises a second team autonomous subsystem and second member autonomous subsystem coupled to each other. The second member executes a second hierarchical plan comprising the team plan and a second member plan. The second member plan is related to one or more self-goals for the second member. The execution comprises the second team autonomous system executing the team plan, and the second member autonomous system executing the second member plan.

In one or more of the above examples, the first member plan is identical to the second member plan.

In one or more of the above examples, the first member plan is different from the second member plan.

In one or more of the above examples, the first team autonomous subsystem comprises a first team autonomous reasoning engine (ARE). The first team ARE comprises a team plan library, a team beliefs processing subsystem, and a team planning subsystem. The team plan library receives the team plan from the second member, and the team beliefs processing subsystem receives at least one message relating to one or more team beliefs from the second member.

In one or more of the above examples, the first member autonomous subsystem comprises a member ARE. The member ARE comprises a member belief processing subsystem. The member belief processing subsystem transmits information relating to one or more member beliefs to the team beliefs processing subsystem. The member ARE comprises a member intentions processing subsystem. The member intentions processing subsystem transmits member telemetry to the team beliefs processing subsystem. The team beliefs processing subsystem ensures that team beliefs stored in the team beliefs processing subsystem are current.

In one or more of the above examples, the team beliefs processing subsystem sends a member belief update to the member beliefs processing subsystem. The member belief update is based on the at least one message relating to one or more team beliefs received from the second member, and the information relating to one or more member beliefs received from the member beliefs processing subsystem.

In one or more of the above examples, the team beliefs processing subsystem transmits the current team beliefs to the team planning subsystem. The team planning subsystem determines one or more member plans, and the team planning subsystem transmits the one or more member plans to the member ARE.

In one or more of the above examples, the team planning subsystem determines the one or more member plans based on the team plan stored in the team plan library, and the current team beliefs received from the team beliefs processing subsystem.

In one example embodiment, a method to implement distributed reasoning for autonomous operation in a team of members. The team of members comprise a first member, wherein the first member comprises a first team autonomous subsystem and first member autonomous subsystem coupled to each other. The method comprises: executing, by the first member, a hierarchical plan comprising a team plan and a first member plan, wherein the team plan is related to one or more team goals, and the first member plan is related to one or more self-goals for the first member, the executing of the hierarchical plan comprises executing, by the first team autonomous subsystem, the team plan, and executing, by the first member autonomous system, the first member plan.

In one or more of the above examples, the team of members comprises a second member coupled to the first member. The second member comprises a second team autonomous subsystem and second member autonomous subsystem coupled to each other. The method comprises: executing, by the second member, a second hierarchical plan comprising the team plan and a second member plan, wherein the second member plan is related to one or more self-goals for the second member. The executing of the second hierarchical plan comprises executing, by the second team autonomous system, the team plan, and executing, by the second member autonomous system, the second member plan.

In one or more of the above examples, the first member plan is identical to the second member plan.

In one or more of the above examples, the first member plan is different from the second member plan.

In one or more of the above examples, the first team autonomous subsystem comprises a first team autonomous reasoning engine (ARE). The first team ARE comprises a team plan library, a team beliefs processing subsystem, and a team planning subsystem. The method comprises: receiving, by the team plan library, the team plan from the second member, and receiving, by the team beliefs processing subsystem, at least one message relating to one or more team beliefs from the second member.

In one or more of the above examples, the first member autonomous subsystem comprises a member ARE. The member ARE comprises a member belief processing subsystem and a member intentions processing subsystem. The method further comprises: transmitting, by the member belief processing subsystem, information relating to one or more member beliefs to the team beliefs processing subsystem, transmitting, by the member intentions processing subsystem, member telemetry to the team beliefs processing subsystem, and ensuring, by the team beliefs processing subsystem, that team beliefs stored in the team beliefs processing subsystem are current.

In one or more of the above examples, the method further comprises: sending, by the team beliefs processing subsystem, a member belief update to the member beliefs processing subsystem. The member belief update is based on the at least one message relating to one or more team beliefs received from the second member, and the information relating to one or more member beliefs received from the member beliefs processing subsystem.

In one or more of the above examples, the method further comprises: transmitting, by the team beliefs processing subsystem, the current team beliefs to the team planning subsystem; determining, by the team planning subsystem, one or more member plans; and transmitting, by the team planning subsystem, the one or more member plans to the member ARE.

In one or more of the above examples, the determining of the one or more member plans is based on the team plan stored in the team plan library, and the current team beliefs received from the team beliefs processing subsystem.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A system for autonomous operation of a device comprising:
an autonomous subsystem comprising:
a first autonomous reasoning engine (ARE) further comprising
a plan library storing one or more plans, wherein
at least some of the one or more plans are available,
an event handling subsystem,
a beliefs processing subsystem,
an intentions processing subsystem, and
a planning subsystem,
wherein the plan library, the event handling subsystem, the beliefs processing subsystem, the intentions processing subsystem and the planning subsystem are communicatively coupled to each other, and
a platform control system (PCS), wherein
the first ARE is coupled to the PCS;
the autonomous subsystem coupled to a workstation, wherein
the workstation transmits
a first one or more messages relating to one or more beliefs to the beliefs processing subsystem, and
a second one or more messages relating to one or more events to the event handling subsystem;
further wherein
the PCS transmits
information relating to one or more perceptions to the beliefs processing subsystem, and
information relating to one or more events to the event handling subsystem,
the beliefs processing subsystem determines a current belief based on the received first one or more messages and the information relating to one or more perceptions,
the beliefs processing subsystem transmits the current belief to the planning subsystem and the intentions processing subsystem,
the event handling subsystem determines a current event based on the received second one or more messages and the information relating to one or more events transmitted by the PCS,
the event handling subsystem transmits the current event to the planning subsystem,
the planning subsystem selects one of the one or more plans stored in the plan library based on
the at least some of the one or more plans which are available,
the current belief, and
the current event,
the planning subsystem transmits the selected plan to the intentions processing subsystem,
the intentions processing subsystem creates a list of intentions based on the received selected plan,
the intentions processing subsystem selects an intention from the created list of intentions for execution based on
the created list of intentions, and
the current belief,
the intentions processing subsystem executes the selected intention, wherein the execution comprises
the intentions processing subsystem creating one or more actions based on the selected intention, and
the intentions processing subsystem transmitting the one or more actions to the PCS.

2. The system of claim 1, wherein
the workstation transmits at least one plan to the plan library for storage;
the workstation comprises a second ARE; and
the workstation comprises an interface to enable an operator to interact with the workstation.

3. The system of claim 1, wherein
the autonomous subsystem comprises a platform specific module (PSM) and a platform;
the first ARE, the PCS, the PSM and the platform are coupled to each other;
the platform comprises platform hardware for operation of the device; and
the PSM converts control and operation of the platform hardware to a uniform standard model.

4. The system of claim 3, wherein
the PSM separates the platform hardware from implementation of one or more algorithms running on the PCS.

5. The system of claim 1, wherein the intentions processing subsystem removes the executed intention from the list of intentions.

6. The system of claim 1, wherein the intentions processing subsystem transmits telemetry to the workstation to enable the workstation to monitor the autonomous subsystem.

7. The system of claim 3, wherein
the PCS receives the one or more actions, and
the PCS converts the one or more actions into commands for control of the platform.

8. The system of claim 1, wherein the one or more perceptions comprise an interpretation of an operating environment.

9. The system of claim 8, wherein the interpretation comprises one of:
information related to a location of an object;
information related to a detected object;
geo-location information; and
positional and motion information.

10. The system of claim 1, wherein the one or more events comprise information related to one or more unexpected occurrences.

11. A method for autonomous operation of a device comprising
storing, by a plan library, one or more plans,
wherein at least some of the one or more plans are available;
transmitting, by a workstation,
a first one or more messages relating to one or more beliefs to a beliefs processing subsystem, and
a second one or more messages relating to one or more events to an event handling subsystem;
transmitting, by a platform control system (PCS),
information relating to one or more perceptions to the beliefs processing subsystem, and
information relating to one or more events to the event handling subsystem;
determining, by the beliefs processing subsystem, a current belief based on the received first one or more messages and the information relating to one or more perceptions;
transmitting, by the beliefs processing subsystem, the current belief to a planning subsystem and an intentions processing subsystem;
determining, by the event handling subsystem, a current event based on the received second one or more messages and the information relating to one or more events;
transmitting, by the event handling subsystem, the current event to the planning subsystem;
selecting, by the planning subsystem, one of the one or more plans stored in the plan library based on
the at least some of the one or more plans which are available,
the current belief, and
the current event;
transmitting, by the planning subsystem, the selected plan to the intentions processing subsystem;
creating, by the intentions processing subsystem, a list of intentions based on the received selected plan;
selecting, by the intentions processing subsystem, an intention from the created list of intentions for execution based on
the created list of intentions, and
the current belief;
executing, by the intentions processing subsystem, the selected intention, wherein the execution comprises
creating, by the intentions processing subsystem, one or more actions based on the selected intention, and
transmitting, by the intentions processing subsystem, the one or more actions to the PCS.

12. The method of claim 11, wherein
the workstation comprises a second ARE;
the workstation comprises an interface to enable an operator to interact with the workstation; and
the method further comprises transmitting, by the workstation, at least one plan to the plan library for storage.

13. The method of claim 11, further comprising:
converting, by a platform specific module (PSM), control and operation of platform hardware within a platform to a uniform standard model.

14. The method of claim 13, wherein the PSM separates the platform hardware from implementation of one or more algorithms running on the PCS.

15. The method of claim 11, further comprising:
removing, by the intentions processing subsystem, the executed intention from the list of intentions.

16. The method of claim 14, further wherein
the plan library,
the event handling subsystem,
the beliefs processing subsystem,
the intentions processing subsystem,
the planning subsystem,
the PSM,
the PCS, and
the platform,
reside on an autonomous subsystem;
the method further comprising transmitting, by the intentions processing subsystem, telemetry to the workstation to enable the workstation to monitor the autonomous subsystem.

17. The method of claim 13, further comprising:
receiving, by the PCS, the one or more actions; and
converting, by the PCS, the one or more actions into commands for control of the platform.

18. The method of claim 11, wherein the one or more events comprise information related to one or more unexpected occurrences.

19. The method of claim 18, wherein the one or more unexpected occurrences comprise one of:
a mechanical failure;
an electrical failure; and
an environmental warning.

20. The method of claim 11, wherein:
the one or more perceptions comprise an interpretation; and
the interpretation comprises one of:
information related to a location of an object;
information related to a detected object;
geo-location information; and
positional and motion information.
